(19) United States
(12) Patent Application Publication
(10) Pub. No.: US 2012/0023009 A1
(43) Pub. Date: Jan. 26, 2012

(54) SYSTEMS AND METHODS FOR PROCESSING CARD FULFILLMENT REQUESTS

(75) Inventors: Sharon Pazlar, Ham Lake, MN (US); Stephen Fuqua, St. Paul, MN (US)

(73) Assignee: FISERV, INC., Brookfield, WI (US)

(21) Appl. No.: 12/842,619

(22) Filed: Jul. 23, 2010

(51) Int. Cl. G06Q 40/00

(52) U.S. Cl. 705/39

(57) ABSTRACT

Systems and methods for processing card fulfillment requests are provided. A card fulfillment request associated with a financial institution and including information associated with an account at the financial institution may be received, and an account identifier for the account may be identified. Information associated with one or more instant issuance requests for the financial institution that have previously been approved for fulfillment may be obtained. Based upon a comparison of the identified account identifier to one or more account identifiers associated with the instant issuance requests, a determination may be made as to whether the identified account identifier corresponds to one of the account identifiers associated with the one or more instant issuance requests. If a correspondence is found, then a determination may be made that the card fulfillment request is not to be fulfilled. Otherwise, a determination may be made that the card fulfillment request be fulfilled.

### FIELD OF THE INVENTION

Aspects of the invention relate generally to payment cards, and more particularly to systems and methods for processing card fulfillment requests.

### BACKGROUND OF THE INVENTION

A wide variety of payment cards and other payment devices are utilized in a wide variety of commercial transactions. A payment card is typically associated with a financial account, such as a bank account maintained at a financial institution or a credit card account maintained by a credit card processor. Payment cards may also include merchant-issued payment cards, stored value cards, and gift cards. Typically, a payment card is issued to a customer when a new account is opened for the customer or when a replacement card is requested by the customer. Additionally, a service provider typically issues replacement payment cards on a periodic basis.

Typically, when a request for a new card is received by a card issuing entity, a card will be generated and mailed to the customer within one or two weeks. In certain circumstances, a card may be generated and issued to a customer while the customer is present at a branch location or other customer service location associated with a financial institution. In this instant issuance scenario, the customer may receive a card immediately rather than wait for the card to be generated and mailed. However, even if a card is issued to a customer in an instant issuance scenario, a duplicate card is often mailed to the customer at a subsequent point in time. Indeed, standard card fulfillment and instant issuance card fulfillment are often treated as different scenarios that are supported by different service providers.

### BRIEF DESCRIPTION OF THE DRAWINGS

Reference will now be made to the accompanying drawings, which are not necessarily drawn to scale, and wherein:

FIG. 1 illustrates an overview of an example system for processing card fulfillment requests, according to an example embodiment of the invention.

FIGS. 2-3 illustrate example data flows for facilitating an instant issuance of a payment card, according to example embodiments of the invention.

FIG. 4 illustrates an example data flow for facilitating central issuance of payment cards, according to an example embodiment of the invention.

FIG. 5 is a flow diagram of an example method for processing card fulfillment requests, according to an example embodiment of the invention.

### DETAILED DESCRIPTION

The invention will now be described more fully hereinafter with reference to the accompanying drawings, in which example embodiments of the invention are shown. This invention may, however, be embodied in many different forms and should not be construed as limited to the example embodiments set forth herein; rather, these example embodiments are provided so that this disclosure will be thorough and complete, and will fully convey the scope of the invention to those of ordinary skill in the art. Like numbers refer to like elements throughout.

Embodiments of the invention may provide systems and methods for processing card fulfillment requests. According to an aspect of the invention, card fulfillment requests may be received, and requests that have previously been fulfilled via an instant issuance technique or procedure may be identified and suppressed. In one example embodiment, a card fulfillment request may be received by a service provider, such as a service provider that supports card fulfillment for a financial institution, merchant, credit card processor, or other entity. The card fulfillment request may correspond to an automatic card renewal, an opening of a new account, or to a customer request for a new card. Additionally, the card fulfillment request may be received as an individual request or as a request that is included in a set of card fulfillment requests. The received card fulfillment request and, if applicable, the set in which the request is included, may be associated with a financial institution. Additionally, the card fulfillment request may include information associated with an account at the financial institution, such as an account number at the financial institution. Based at least in part upon the received card fulfillment request, an account identifier associated with the account may be identified. A wide variety of account identifiers may be utilized as desired in various embodiments of the invention. For example, an account number for the account may be utilized as an account identifier. As another example, the account number may be encrypted, processed, or otherwise utilized to generate an account identifier.

Information associated with one or more instant issuance requests for the financial institution may then be obtained. The obtained information may be associated with requests that have previously been approved for fulfillment. Additionally, the obtained information may include a respective account identifier (e.g., an account number or other account identifier) associated with each of the one or more approved instant issuance requests. The instant issuance information may be obtained by accessing the information from memory and/or by receiving the information from one or more remote data sources. Once the instant issuance information is obtained, a determination may be made as to whether the received card fulfillment request corresponds to one of the approved instant issuance requests. For example, based at least in part upon a comparison of the account identifier associated with the card fulfillment request to at least one of the one or more account identifiers associated with the one or more instant issuance requests, a determination may be made as to whether the account identifier associated with the card fulfillment request corresponds to one of the account identifiers associated with the one or more instant issuance requests. If it is determined that a correspondence exists, then a determination may be made that the card fulfillment request is not to be fulfilled. In certain embodiments, the card fulfillment request may be removed from a set of card fulfillment requests. Otherwise, if it is determined that a correspondence does not exist, then a determination may be made that the card fulfillment request be fulfilled. As desired, the card fulfillment requests may be maintained in a set of card fulfillment requests or written to a new order for one or more card fulfillment requests. Additionally, as desired, a direction or instruction to fulfill the request may be generated and communicated to a fulfillment entity.

As used herein, the term “card” generally refers to a payment card or other suitable payment device that may be associated with a financial, credit, or stored value account at an entity such as financial institution or merchant and that may be utilized by a consumer or customer to complete payment transactions. Examples of suitable payment cards include, but are not limited to, plastic payment cards (e.g., bank cards, debit cards, stored value cards, etc.), contactless payment cards or contactless payment devices, smart cards, etc. Additionally, the terms “card,” “payment card,” and “payment device” may be utilized interchangeably. Although card fulfillment requests are described below as being associated with cards for a financial institution (e.g., a bank), embodiments of the invention may be utilized to fulfill card requests for a wide variety of suitable entities that issue cards and manage and/or maintain financial accounts associated with issued cards. Examples of suitable entities include, but are not limited to, financial institutions, credit card issuers, stored value card issuers, merchants, etc.

I. System Overview

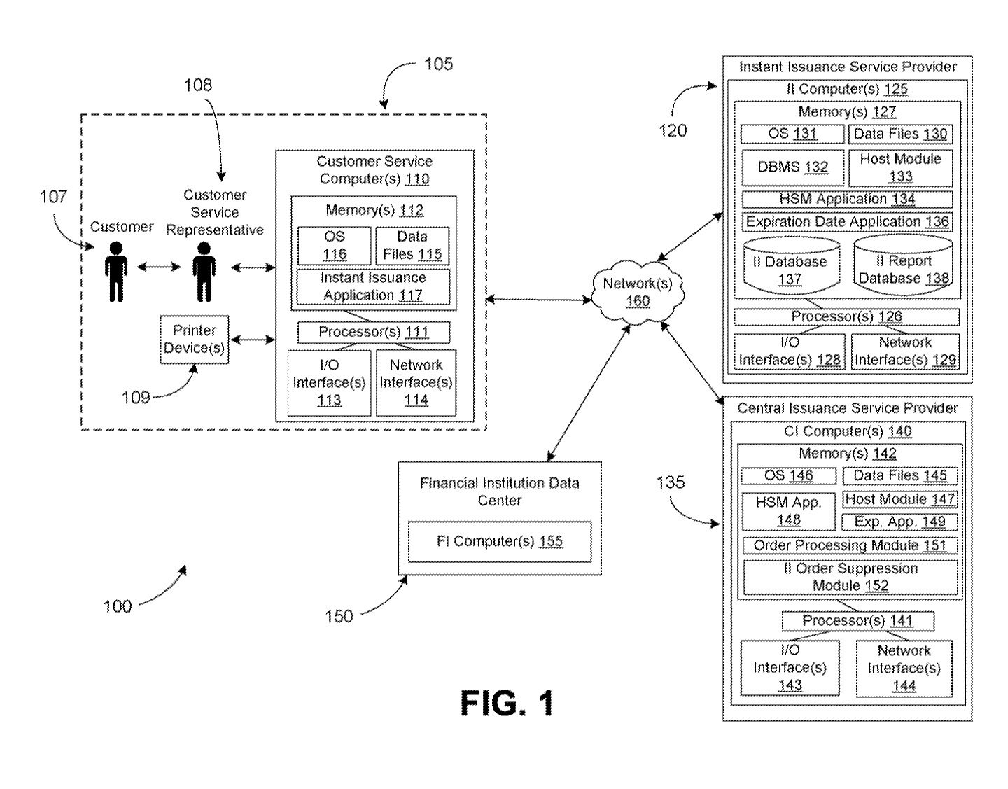

FIG. 1 illustrates an overview of an example system 100 for processing card fulfillment requests, according to an example embodiment of the invention. Although various computing devices and/or computers are illustrated in FIG. 1, it is appreciated that corresponding entities and/or individuals are associated with each of the computers illustrated. According to various embodiments, there may be: one or more customer service locations 105 that are associated with or support a financial institution (or other card issuing entity), each customer service location 105 associated with one or more customer service computers 110 or customer service computing devices; one or more instant issuance service providers 120 that support the financial institution (or other card issuing entity), each associated with one or more instant issuance (“II”) computers 125 or instant issuance computing devices; one or more central issuance service providers 135 that support the financial institution (or other card issuing entity), each associated with one or more central issuance (“CI”) computers 140 or central issuance computing devices; and one or more financial institution data centers 150 (e.g., systems associated with banks), each associated with one or more financial institution (“FI”) computers 155 or financial institution computing devices. According to various embodiments, there may be any number of each entity type, and each entity may be associated with any number of suitable computers, computing devices, and/or other devices. For simplicity, the computers, devices, and/or entities may be referenced in the singular, but it is appreciated that the same description applies to embodiments including multiple computers, devices and/or entities. Similarly, for each of the computers described herein, it is appreciated that the computer may include any number of suitable components and/or functionality.

As shown in FIG. 1, one or more of a customer service computer 110, an II computer 125, a CI computer 140, and/or a FI computer 155 may be in communication with each other via any number of suitable networks 160, which, as described below, can include one or more separate or shared private and/or public networks, including the Internet or a publicly switched telephone network. More specifically, according to various embodiments, a request for a card may be received at a customer service location 105, and the customer service computer 110 may be utilized to process the request. In certain embodiments, an instant issuance process may be utilized to issue a card to a customer at the customer service location 105. As desired, the customer service computer 110 may communicate with the II computer 125 in order to process the card request and facilitate the instant issuance of the card. In other embodiments, a central issuance process may be utilized to provide a card to the customer. For example, the customer service computer 110 may communicate with the CI computer 140 in order to process the card request and facilitate the subsequent mailing of a card to the consumer. Additionally, as explained in greater detail below, the CI computer 140 and/or other components of the system 100 may be configured to suppress the central issuance of a card if the card has previously been provided to a consumer by an instant issuance process.

The customer service location 105 may be any suitable location at which a customer 107 or a consumer may request and/or receive a requested card. For example, the customer service location 105 may be a branch location of a financial institution or bank, a call center, a merchant location, or any other suitable location that facilitates the receipt and/or processing of card requests. In certain embodiments, the customer 107 may interact with a customer service representative (“CSR”) 108, such as a teller, call center representative, or other customer-facing financial institution employee, at the customer service location 105. For example, the customer 107 may interact with the CSR 108 to open a new account or request a replacement card for an existing account. As an alternative to interacting with a CSR 108, a customer 107 may interact with a suitable kiosk or other computing device that facilitates the opening of an account and/or the requesting of a replacement card.

In certain embodiments, the customer service computer 110 may be utilized to collect information associated with a customer request for a card, and the customer service computer 110 may process the request. For example, the CSR 108 (or the customer 107) may utilize the customer service computer 110 to enter information associated with a card request and/or customer preferences associated with a requested card. The customer service computer 110 may interact with one or more other components of the system 100, such as the II computer 125, the CI computer 140, and/or the FI computer 155, in order to request that a card be mailed or otherwise communicated to the customer 107 or that an instant issuance process be utilized to issue a card to the customer 107. For example, in an instant issuance process, the customer service computer 110 may interact with the II computer 125 and/or the FI computer 155 in order to obtain various values that will be included on a requested card, such as an expiration date, one or more key values associated with the card, etc. Once desired information is obtained, the customer service computer 110 may direct a suitable printer device 109 to print the card for issuance to the customer 107.

A wide variety of suitable types of card printer devices 109 may be utilized as desired in various embodiments of the invention, such as thermal transfer printers, dye sublimation printers, reverse imaging printers, and/or other suitable card printers. Additionally, as desired, a wide variety of programming devices may be utilized to initialize, program, and/or personalize a card that is issued to the customer 107. For example, a suitable radio frequency (“RF”) transceiver may be utilized to program and/or personalize an RF chip that is included on a payment card. As another example, a suitable encoding device may be utilized to encode or program a magnetic stripe associated with a card. For purposes of this disclosure, the term card printer device 109 or card printing device is utilized to refer to any device and/or combination of devices that facilitate the preparation, initialization, programming, and/or personalization of a card that is provided to the customer 107. Once a card has been printed, the card may be retrieved from the printer device 109 by the CSR 108 or by the customer 107.

With continued reference to the customer service location 105, the customer service computer 110 may be any suitable processor-driven device that facilitates the receipt and/or processing of a request for a new card or a replacement card, such as a server computer, a mainframe computer, one or more networked computers, a desktop computer, a personal computer, a digital assistant, a personal digital assistant, a digital tablet, an Internet appliance, an application specific circuit, a microcontroller, a minicomputer, or any other processor-based device. The execution of suitable computer-implemented instructions by the customer service computer 110 may form a special purpose computer or other particular machine that is operable to facilitate the processing of card requests made by the customer 107 and/or the CSR 108. Although a single customer service computer 110 is described herein, the operations and/or control of the customer service computer 110 may be distributed among any number of computers and/or processing components.

in addition to having one or more processors 111, the customer service computer 110 may include one or more memory devices 112, one or more input/output (“I/O”) interface(s) 113, and one or more network interface(s) 114. The memory devices 112 may be any suitable memory devices, for example, caches, read-only memory devices, random access memory devices, magnetic storage devices, removable storage devices, etc. Additionally, any number of logical data storage constructs may be stored as desired within the memory devices 112, such as any number of suitable databases. The memory devices 112 may store a wide variety of data, such as data files 115. Additionally, the memory devices 112 may store executable instructions and/or various program modules utilized by the customer service computer 110, for example, an operating system (“OS”) 116 and/or an instant issuance application 117.

The data files 115 may include any suitable data that facilitates the receipt and/or processing of card requests by the customer service computer 110, such as instant issuance card requests. For example, the data files 115 may include data associated with an account number for a requested card, customer identifying information (e.g., customer name, etc.), data associated with one or more customer preferences associated with a requested card (e.g., desired background art, personalized images, desired name to be printed on the card, etc.), data associated with one or more servers or service providers that facilitate the issuance of a card (e.g., data associated with the II computer 125, FI computer 155, etc.), and/or card data received from one or more servers that facilitate the issuance of a card (e.g., one or more key values, an expiration date, etc.). The OS 116 may be a suitable software module that controls the general operation of the customer service computer 110. The OS 116 may also facilitate the execution of other software modules by the one or more processors 111, for example, the instant issuance application 117. The OS 116 may be, but is not limited to, Microsoft Windows®, Apple OSX™, Linux, Unix, or a mainframe operating system.

The instant issuance application 117 may be operable, configured, and/or programmed to receive information associated with a card request and/or to process the received card request. In operation, the CSR 108 and/or the customer 107 may utilize the instant issuance application 117 to enter information and/or preferences associated with a card request (e.g., an account holder's name, an account number, desired graphics, etc.). Additionally, as desired, certain information associated with a new card, such as a new account number, may be generated by the instant issuance application 117. The instant issuance application 117 may then utilize at least a portion of the received, entered, and/or generated information to initiate a card generation process. For example, the instant issuance application 117 may generate and direct the communication of a request for a new card to a suitable server application that returns one or more card-specific values to the instant issuance application 117, such as one or more key values for the card (e.g., a card verification value, a PIN verification value, etc.) and/or an expiration date for the card. The request may be communicated to a wide variety of different servers or computers as desired in various embodiments of the invention, such as the II computer 125, the FI computer 155, etc. Additionally, in certain embodiments, the request may be communicated to the recipient server in real time or near real time. In response to a request, various generated values (e.g., an expiration date and/or one or more key values) may be returned to the instant issuance application 117, and the instant issuance application 117 may utilize the received values to complete the generation of the card. For example, the instant issuance application may combine the received values, entered values and preferences, and/or a template for a card to generate a final version of the card. The instant issuance application 117 may then direct the printer device 109 to print and/or personalize the card.

Additionally, in certain embodiments, the instant issuance application 117 may store information associated with card requests that are transmitted or communicated to one or more recipient servers. The instant issuance application 117 may additionally store information associated with card requests that have been fulfilled. As desired, the instant issuance application 117 may communicate at least a portion of the stored information to one or more recipients, such as the II computer 125, the CI computer 140, and/or the FI computer 155. For example, the instant issuance application 117 may communicate information associated with requested cards and/or fulfilled card requests to a recipient in a periodic manner, such as once a day.

With continued reference to the customer service computer 110, the one or more I/O interfaces 113 may facilitate communication between the customer service computer 110 and one or more input/output devices, for example, one or more user interface devices, such as a display, keypad, mouse, pointing device, control panel, touch screen display, remote control, microphone, speaker, etc., that facilitate user interaction with the customer service computer 110. The one or more network interfaces 114 may facilitate connection of the customer service computer 110 to one or more suitable networks, for example, the networks 160 illustrated in FIG. 1. In this regard, the customer service computer 110 may receive and/or communicate information to other components of the system 100, such as the II computer 125, the CI computer 140, and/or the FI computer 155.

With continued reference to FIG. 1, the II computer 125 may be configured to facilitate the processing of instant issuance requests that are received from any number of customer service computers, such as the customer service computer 110 illustrated in FIG. 1. The II computer 125 may be associated with an underlying instant issuance service provider 120. Alternatively, as described in greater detail below, the FI computer 155 may be configured to process an instant issuance request that is received from a customer service computer 110. The II computer 125 may be any suitable processor-driven device, such as a server computer, a mainframe computer, one or more networked computers, a desktop computer, a personal computer, a digital assistant, a personal digital assistant, a digital tablet, an Internet appliance, an application specific circuit, a microcontroller, a minicomputer, or any other processor-based device. The execution of suitable computer-implemented instructions by the II computer 125 may form a special purpose computer or other particular machine that is operable to facilitate the processing of an instant issuance request in order to generate and return one or more card-specific values to a requesting entity or system. Additionally or alternatively, the execution of suitable computer-implemented instructions by the II computer 125 may form a special purpose computer or other particular machine that is operable to store data associated with instant issuance requests that have been made and/or instant issuance requests that have been fulfilled. Although a single II computer 125 is described herein, the operations and/or control of the II computer 125 may be distributed among any number of computers and/or processing components.

In addition to having one or more processors 126, the II computer 125 may include one or more memory devices 127, one or more input/output (“I/O”) interface(s) 128, and one or more network interface(s) 129. The memory devices 127, I/O interfaces 128, and/or network interfaces 129 may be similar to those described above with reference to the customer service computer 110. As such, the memory devices 127 may store a wide variety of data and/or data repositories, such as data files 130, an instant issuance database 137, and an instant issuance report database 138. Additionally, the memory devices 127 may store executable instructions and/or various program modules utilized by the II computer 125, for example, an operating system (“OS”) 131, a database management system (“DBMS”) 132, one or more host modules 133, a host security module (“HSM”) application 134, and/or an expiration date application 136 or module.

The data files 130 may include, for example, any suitable data that facilitates the processing of an instant issuance request, such as information associated with an HSM application 134 and/or an expiration date application 136 that may be utilized by and/or accessed by the II computer 125. The II database 137 may include information associated with received instant issuance requests and card-specific values that are generated for the requests. A wide variety of information may be stored in the II database 137 for an instant issuance request, such as an account number, a name of an account holder, one or more generated key values, a generated expiration date, a date on which the request was received, etc. As desired, certain information may be encrypted or encoded prior to the storage of the information in the II database 137. For example, an account number may be encrypted using a one-way hash or other suitable encryption technique prior to the storage of the account number. As desired, the term “account number” may be utilized to refer to an unencrypted or encrypted version of the account number. The II report database 138 may include information associated with instant issuance requests that have been fulfilled at any number of customer service locations 105. For example, information associated with fulfilled requests may be periodically received from customer service locations 105 and stored in the II report database 138. Similar to the II database 137, the II report database 138 may be utilized to store a wide variety of information associated with the fulfillment of instant issuance requests, such as an account number, a name of an account holder, one or more generated key values, a generated expiration date, a date on which the request was received, etc. Additionally, certain information (e.g., an account number) may be encrypted or encoded prior to being stored in the II report database 138. As an alternative to maintaining a separate II report database 138, an indication of whether an instant issuance request has been fulfilled (i.e., a card issued to a customer 107) may be stored in the II database 137.

The OS 131 may be a suitable software module that controls the general operation of the II computer 125 and/or the execution of other software modules by the one or more processors 126. The OS 131 may be similar to the OS 116 for the customer service computer 110. The DBMS 132 may facilitate the management of the information stored in the II database 137 and/or the II report database 138. The host module(s) 133 may facilitate the receipt of instant issuance requests from any number of customer service computers 110, FI computers 155, and/or other components of the system 100. As such, the host module(s) 133 may include any number of suitable host modules, such as Web servers, email servers, and/or short message service (“SMS”) processing applications, including various dedicated applications, that facilitate interaction with a device that communicates an instant issuance request. As desired, various host modules 133 may be provided and/or customized for access by different financial institutions and/or requesting entities. In certain embodiments, a host module 133 may receive requests directly from a customer service computer 110. In other embodiments, requests may be sent from the customer service computer 110 to a host module 133 via one or more intermediate devices, such as the FI computer 155. Once a request is received, a host module 133 may facilitate the processing of the request in order to return card-specific values to a requester. In doing so, the host module 133 may invoke the HSM application 134 and/or the expiration date application 136. Alternatively, the host module 133 may communicate requests for various data to the HSM application 134 and/or the expiration date application 136. Once values have been obtained from the HSM application 134 and/or the expiration date application 136, the host module 133 may return these values to a card requester to facilitate the generation of a card. Additionally, the host module 133 may direct the storage of information associated with the instant issuance request and/or card-specific values in the II database 137.

The HSM application 134 may be programmed or configured to generate one or more key values that will be associated with a generated card. A wide variety of key values may be generated by an HSM application 134, such as a card verification value (“CVV”), a PIN verification value (“PVV”), or another PIN-related value. In certain embodiments, the HSM application 134 may be executed by the II computer 125. In other embodiments, the HSM application 134 may be executed by a separate computer in communication with the II computer 125, such as a second II computer in communication with the II computer 125 via a local area network or a computer that is operated by a remote entity and in communication with the II computer 125 via one or more intervening networks (e.g., a wide area network). As such, the HSM application 134 may be tightly or loosely coupled with the host module 133. The expiration date application 136 may be programmed or configured to determine a card expiration date that will be associated with a generated card. Similar to the HSM application 134, the expiration date application 136 may be tightly or loosely coupled to the host module 133.

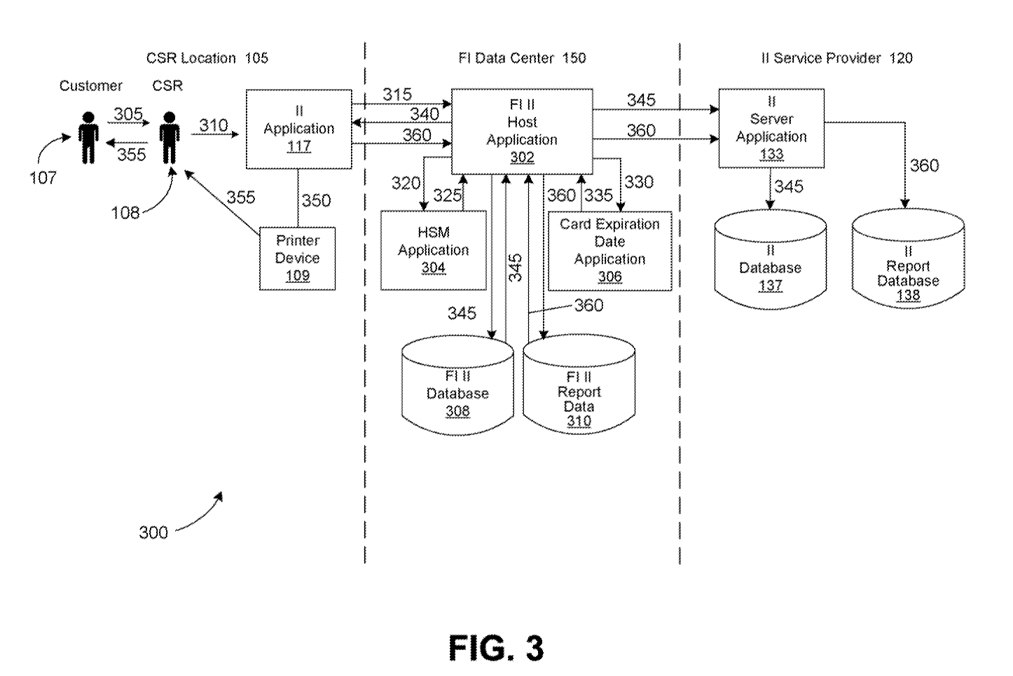

With continued reference to FIG. 1, any number of FI computers 155 may be provided. As desired, a FI computer 155 may perform similar operations to those described above for the II computer 125. For example, as described in greater detail below with reference to FIG. 3, a FI computer 155 may be configured to facilitate the processing of instant issuance requests that are received from any number of customer service computers, such as the customer service computer 110 illustrated in FIG. 1. The FI computer 155 may be associated with an underlying financial institution data center 150, such as a bank data center that facilitates the processing of card requests and/or the issuance of cards. The FI computer 155 may be a suitable processor-driven device that is similar to the II computer 125. As such, the FI computer 155 may include components similar to those described above for the II computer 125.

In certain embodiments, a FI computer 155 may receive an instant issuance request from a customer service computer 110. As desired, the FI computer 155 may process the request and return card-specific values to the customer service computer 110. In doing so, the FI computer 155 may directly access and/or interact with an appropriate HSM application and/or expiration date application, as described above with reference to the II computer 125. Alternatively, the FI computer 155 may generate an instant issuance request that is communicated to the II computer 125 for processing. Once card-specific values are determined and/or received by the FI computer 155, the FI computer 155 may return the card-specific values to the customer service computer 110 in order to facilitate the generation of a card. Additionally, the FI computer 155 may store information associated with instant issuance requests and/or the fulfillment of instant issuance requests. For example, the FI computer 155 may include an II database and/or an II report database that are similar to those described above with reference to the II computer 125. As desired, the FI computer 155 may communicate at least a portion of the information stored in the databases to the II computer 125. In this regard, relatively up-to-date information may be maintained by both the FI computer 155 and the II computer 125.

Additionally, in certain embodiments, a suitable FI computer 155 may request the central issuance of any number of payment cards. For example, a FI computer 155 may generate or prepare an order file or order set of any number of central issuance requests that are associated with the financial institution. The FI computer 155 may then communicate the central issuance order file and/or or individual central issuance requests to the CI computer 140.

With continued reference to FIG. 1, the CI computer 140 may be configured or programmed to facilitate the processing of central issuance card requests. In certain embodiments, the CI computer 140 may receive a list of card fulfillment requests (e.g., new card requests, card renewals, and/or replacement card requests), and the CI computer 140 may facilitate the processing of the requests in order to generate cards. According to an aspect of the invention, the CI computer 140 may identify one or more central issuance requests that have previously been fulfilled by an instant issuance process, and the CI computer 140 may suppress the central issuance of the one or more requests. The CI computer 140 may be associated with an underlying central issuance service provider 135. In certain embodiments, the central issuance service provider 135 and the instant issuance service provider 120 may be a single entity. Accordingly, as desired, the CI computer 140 and the II computer 125 may be the same computer. The CI computer 140 may be any suitable processor-driven device, such as a server computer, a mainframe computer, one or more networked computers, a desktop computer, a personal computer, a digital assistant, a personal digital assistant, a digital tablet, an Internet appliance, an application specific circuit, a microcontroller, a minicomputer, or any other processor-based device. The execution of suitable computer-implemented instructions by the CI computer 140 may form a special purpose computer or other particular machine that is operable to facilitate the processing of central issuance card fulfillment requests and/or the suppression of card requests that have previously been fulfilled via an instant issuance process. Although a single CI computer 140 is described herein, the operations and/or control of the CI computer 140 may be distributed among any number of computers and/or processing components.

In addition to having one or more processors 141, the CI computer 140 may include one or more memory devices 142, one or more input/output (“I/O”) interface(s) 143, and one or more network interface(s) 144. The memory devices 142, I/O interfaces 143, and/or network interfaces 144 may be similar to those described above with reference to the customer service computer 110. As such, the memory devices 142 may store a wide variety of data and/or data repositories, such as data files 145. Additionally, the memory devices 142 may store executable instructions and/or various program modules utilized by the CI computer 140, for example, an operating system (“OS”) 146, one or more host modules 147, a host security module (“HSM”) application 148, an expiration date application 149 or module, an order processing module 151, and/or an instant issuance order suppression module 152.

The data files 145 may include, for example, any suitable data that facilitates the processing of a central issuance request, such as one or more order lists for central issuance cards and/or information associated with an HSM application 148 and/or an expiration date application 149 that may be utilized by and/or accessed by the CI computer 140. The OS 146 may be a suitable software module that controls the general operation of the CI computer 140 and/or the execution of other software modules by the one or more processors 141. The OS 146 may be similar to the OS 116 for the customer service computer 110. The host module(s) 147 may facilitate the receipt of central issuance requests and/or central issuance order forms from any number of order data sources or ordering entities, such as one or more financial institution data centers, merchants, etc., that desire cards to be issued to customers or consumers. As desired, the host module(s) 147 may include any number of suitable Web servers, email servers, and/or short message service (“SMS”) processing applications, including various dedicated applications, that facilitate interaction with one or more ordering entities. Alternatively, ordering data may be provided to a host module 147 or other component of the CI computer 140 via manual entry and/or loading from a suitable memory device (e.g., CD-ROM, memory card, etc.). Once one or more orders and/or order lists have been received, the host module 147 may facilitate the processing of the orders. As desired, the host module 147 may invoke one or more of the other components or software modules of the CI computer 140 to facilitate the processing of orders. For example, the host module 147 may invoke the HSM application 148 and/or the expiration date application 149 to facilitate the generation of card-specific values to be included on generated cards. As another example, the host module 147 may invoke the order processing module 151 to facilitate the further processing of orders and, as desired, the fulfillment of orders. As yet another example, the host module 147 may invoke the II order suppression module 152 to facilitate the identification of and removal of orders that have previously been fulfilled via an instant issuance process.

The HSM application 148 and the expiration date application 149 may be similar to the HSM application 134 and expiration date application 136 described above for the II computer 125. In embodiments in which the CI computer 140 facilitates the fulfillment of central issuance requests, the HSM application 148 and the expiration date application 149 may be utilized to generate various card-specific values that are utilized in the fulfillment of card requests and/or orders. Additionally, the HSM application 148 and/or the expiration date application 149 may be tightly or loosely coupled to the host module 147 as desired in various embodiments of the invention.

The order processing module 151 may be programmed or configured to obtain and/or receive central issuance card orders via the host module 147. For example, one or more orders may be received or obtained from any number of financial institution data centers and/or FI computers 155. Because instant issuance processing and central issuance processing are typically not integrated within a financial institution, central issuance orders may include duplicates of orders that have previously been fulfilled utilizing an instant issuance process. The order processing module 151 may invoke and/or work in conjunction with the II order suppression module 152 to identify and remove previously fulfilled instant issuance orders. In this regard, the issuance of duplicate cards may be reduced or avoided, leading to a cost savings on the part of the entity that requested the cards (e.g., financial institution, merchant, etc.) Once previously fulfilled card orders or card requests have been removed, the order processing module 151 may generate a revised order list of card requests to be fulfilled. In certain embodiments, the order processing module 151 may communicate the revised order list to one or more service providers or entities for fulfillment. In other embodiments, the order processing module 151 may further be configured to process the remaining central issuance orders in order to direct the generation of cards to be mailed or otherwise delivered to various customers.

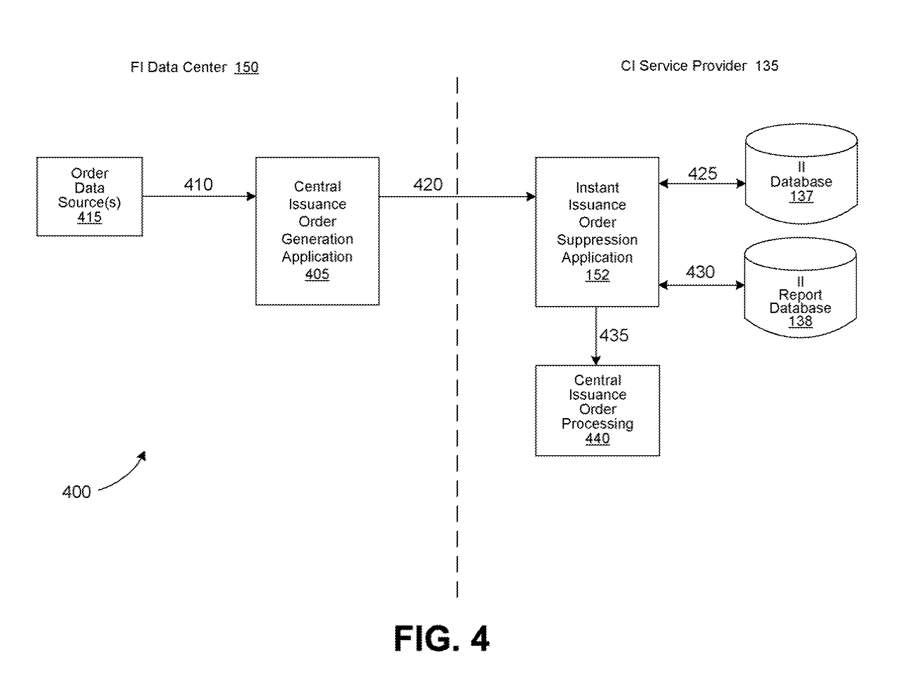

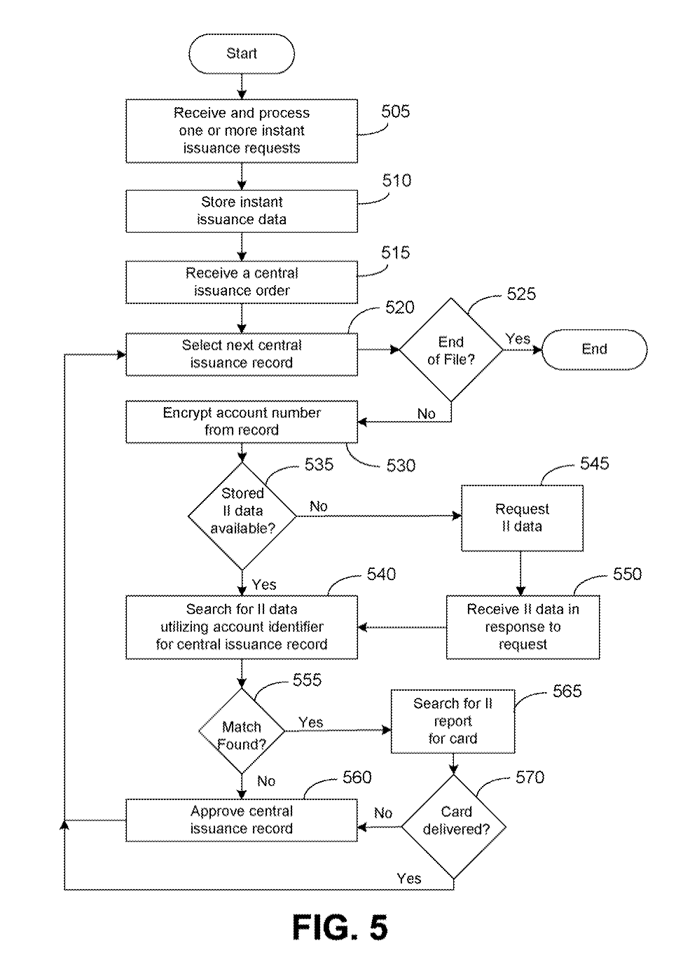

The II order suppression module 152 may be configured or programmed to determine whether one or more central issuance orders have previously been fulfilled via an instant issuance process. Orders that have previously been fulfilled may be removed from an order list for central issuance cards. In certain embodiments, the II order suppression module 152 may obtain and/or store data associated with previously requested and/or fulfilled instant issuance requests. For example, the II order suppression module 152 may obtain information from the II databases 137 and/or II report databases 138 associated with the II computer 125 and/or the FI computer 155. When a central issuance order or request is received by the II order suppression module 152, the module 152 may compare information associated with the central issuance request to at least a portion of the information associated with instant issuance requests. If a match is found, then the II order suppression module 152 may mark the central issuance request as previously fulfilled and/or direct the removal of the central issuance request from an order list. In this regard, the central issuance request may be suppressed. Examples of the operations of the II order suppression module 152 are described in greater detail below with reference to FIGS. 4 and 5.

The networks 160 may include any telecommunication and/or data networks, whether public, private, or a combination thereof, including but not limited to, a local area network, a wide area network, an intranet, the Internet, intermediate handheld data transfer devices, public switched telephone networks, and/or any combination thereof and may be wired and/or wireless.

Those of ordinary skill in the art will appreciate that the system 100 shown in and described with respect to FIG. 1 is provided by way of example only. Numerous other operating environments, system architectures, and device configurations are possible. Other system embodiments can include fewer or greater numbers of components and may incorporate some or all of the functionality described with respect to the system components shown in FIG. 1. Accordingly, embodiments of the invention should not be construed as being limited to any particular operating environment, system architecture, or device configuration.

II. Operational Overview—Instant Issuance

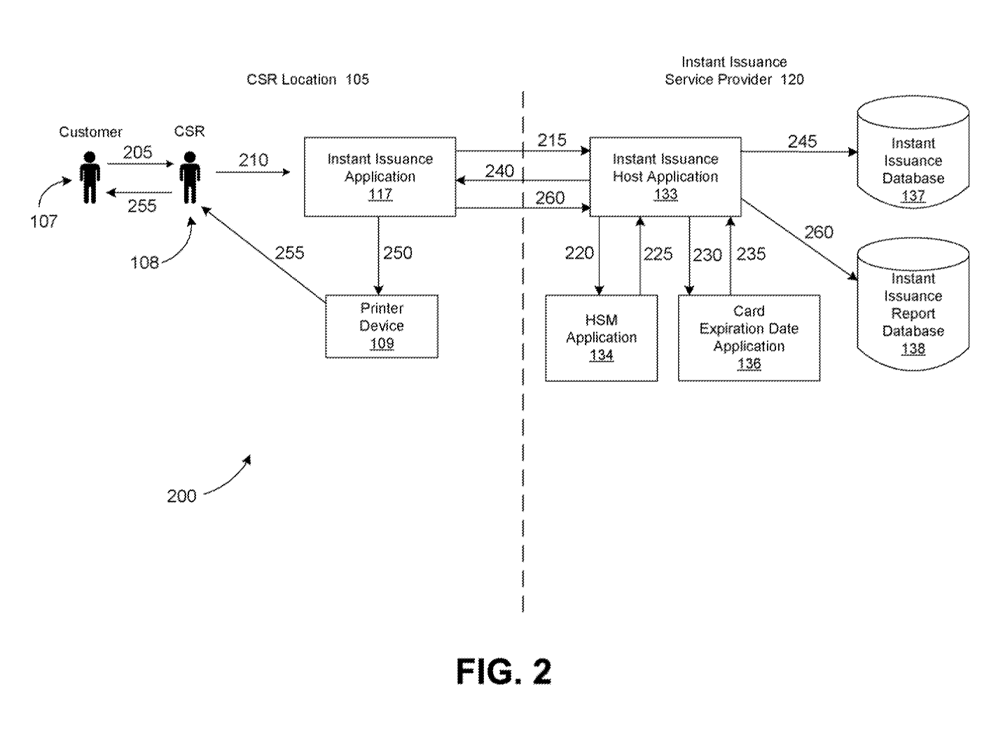

FIGS. 2-3 illustrate example data flows for facilitating an instant issuance card generation process, according to example embodiments of the invention. FIG. 2 illustrates an example data flow 200 in which an instant issuance service provider, such as the service provider 120 illustrated in FIG. 1, facilitates the processing of an instant issuance request.

With reference to FIG. 2, a customer, such as the customer 107 illustrated in FIG. 1, may provide a request 205 to a customer service representative (“CSR”), such as the CSR 108 illustrated in FIG. 1. The CSR 108 may be located at a suitable customer service location or CSR location, such as the customer service location 105 illustrated in FIG. 1. The request 205 may be a request for a new account or a request for a new card or a replacement card. A wide variety of information may be included in the request as desired in various embodiments, such as an account holder's name, an account number (if available), and/or various customer preferences for a card. The CSR 108 may receive the request 205 and enter pertinent information 210 into a customer service computer for receipt by a suitable instant issuance application, such as the application 117 illustrated in FIG. 1. In certain embodiments, the instant issuance application 117 may be located or situated at a secure location within the CSR location 105.

The instant issuance application 117 may generate an instant issuance request 215 that is communicated to an instant issuance host application, such as the host module 133 illustrated in FIG. 1 as a component of an II computer 125. The instant issuance request 215 may include a request for card-specific information to be included in a generated card, such as one or more key values and/or an expiration date. Additionally, the instant issuance request 215 may include a wide variety of information associated with the requested card, such as an account holder's name, other account holder information, an account number or account identifier, an image or personalized graphic selection, etc. In certain embodiments, the instant issuance request 215 may be communicated to the instant issuance host application 133 in real time or near-real time while a customer 107 is present within the CSR location 105.

The host application 133 may receive the instant issuance request 215, and the host application 133 may process the received request 215 in order to return the requested card-specific values to the instant issuance application 117. The host application 133 may communicate, to a suitable host security module (“HSM”) application such as the HSM application 134 illustrated in FIG. 1, a request 220 to generate one or more key values that will be associated with the card to be issued. In response to the received request 220, the HSM application 134 may return one or more key values 225 to the host application 133. In certain embodiments, the key values 225 may be card-specific values that are generated by the HSM application 134. As desired, a wide variety of key values 225 may be utilized as desired in various embodiments of the invention, such as a CVV, a PVV, or another PIN-related value.

The host application 133 may also communicate, to a suitable card expiration date application, such as the card expiration date application 136 illustrated in FIG. 1, a request 230 to determine an expiration date for the card to be issued. In response to the received request 230, the expiration date application 136 may determine an expiration date 235 for an account associated with the card based on any number of business rules, such as business rules associated with a financial institution, merchant, etc. The expiration date 235 may then be returned to the host application 133 by the card expiration date application 136. Once the host application 133 has received the key values 225 and the expiration date 235, the host application 133 may generate a message 240 including these card-specific values, and the host application 133 may communicate or direct the communication of the generated message 240 to the instant issuance application 117 to facilitate the issuance of the card.

Additionally, the instant issuance host application 133 may store or save information 245 associated with the instant issuance request 215 and/or the processing of the instant issuance request 215 in a suitable instant issuance database, such as the II database 137 illustrated in FIG. 1. A wide variety of information 245 may be stored in the II database as desired in various embodiments of the invention, including but not limited to, an indication of the instant issuance request 215, information included in the instant issuance request 215 (e.g., account holder's name, account number, etc.), a copy of the instant issuance request 215, the key values 225, and/or the expiration date 235. As desired, certain information may be encrypted or encoded prior to storage. For example, in compliance with various card association regulations, an account number may be encrypted by a one-way hash or other suitable encryption technique prior to the storage of the account number. As a result of storing information 245 or a record associated with the instant issuance request 215, a data store of instant issuance requests that are processed at various CSR locations 105 may be maintained.

With continued reference to FIG. 2, once the generated message 240 is received by the instant issuance application 117, the instant issuance application 117 may utilize the card-specific values included in the message 240 to direct the printing of a card. For example, the card-specific values may be combined with a template for a card, such as a template that includes a default card image or a customer-selected card image. The resulting combination 250 may then be sent to a suitable printer device, such as the printer device 109 illustrated in FIG. 1. The printer device 109 may then print, initialize, and/or personalize a card 255. The CSR 108 may retrieve the card 255 from the printer device 109 and provide the card 255 to the customer 107.

Additionally, the instant issuance application 117 may communicate a report or message associated with the final or ultimate processing of the instant issuance request 215 to the host application 133. For example, the instant issuance application 117 may periodically (e.g., once an hour, once a day, etc.) communicate, to the host application 133, a summary 260 of the instant issuance requests that have been processed by the instant issuance application 117 during the most recent reporting period. As desired, the communication may be initiated by the instant issuance application 117 or sent in response to a request received from the host application 133. Additionally, the summary 260 may include a wide variety of information associated with the processing of instant issuance requests, such as an audit trail associated with the disposition of the instant issuance requests. For example, the summary 260 may indicate, for each request, whether a card was delivered and, if a card was not delivered, a reason for the delivery failure (e.g., an indication that the process was aborted, a card production failure, etc.).

The host application 133 may receive the summary 260 from the instant issuance application 117, and the host application 133 may direct the storage of at least a portion of the information included in the summary 260 in a suitable instant issuance report database, such as the II report database 138 illustrated in FIG. 1. As desired, certain information may be encrypted or encoded prior to storage. For example, in compliance with various card association regulations, an account number may be encrypted by a one-way hash or other suitable encryption technique prior to the storage of the account number. In this regard, a data store of the instant issuance requests that have been fulfilled or completed may be maintained. As an alternative to storing summary information in the II report database 138, the summary information may be stored in the II database 137 along with the corresponding instant issuance request data.

It will be appreciated that variations of the data flow 200 illustrated in FIG. 2 may be utilized in accordance with various embodiments of the invention. For example, FIG. 3 illustrates an example data flow 300 in which financial institution (“FI”) data center, such as the data center 150 illustrated in FIG. 1, facilitates the processing of an instant issuance request. The FI data center 150 may perform similar functions to those described in FIG. 2 above for the II service provider 120. Additionally, the FI data center 150 may communicate instant issuance request data and/or instant issuance report data to the II service provider 120. In this regard, copies of the instant issuance request and report data may be separately maintained by the FI data center 150 and the II service provider 120.

With reference to FIG. 3, a customer, such as the customer 107 illustrated in FIG. 1, may provide a request 305 to a customer service representative (“CSR”), such as the CSR 108 illustrated in FIG. 1. The CSR 108 may be located at a suitable customer service location or CSR location, such as the customer service location 105 illustrated in FIG. 1. The request 305 may be a request for a new account or a request for a new card or a replacement card, and the request 305 may include an account holder's name, an account number (if available), various customer preferences for a card, and/or other card request information. The CSR 108 may receive the request 305 and enter pertinent information 310 into a customer service computer for receipt by a suitable instant issuance application, such as the application 117 illustrated in FIG. 1.

The instant issuance application 117 may generate an instant issuance request 315 that is communicated to a suitable financial institution instant issuance host application 302. The instant issuance request 315 may include a request for card-specific information to be included in a generated card. Additionally, the instant issuance request 315 may include a wide variety of information associated with the requested card, such as an account holder's name, other account holder information, an account number or account identifier, an image or personalized graphic selection, etc.

The host application 302 may receive the instant issuance request 315, and the host application 302 may process the received request 315 in order to return the requested card-specific values to the instant issuance application 117. The host application 302 may communicate, to a suitable host security module (“HSM”) application 304, a request 320 to generate one or more key values that will be associated with the card to be issued. In response to the request 320, the HSM application 304 may return one or more key values 325 (e.g., a CVV, a PVV, or another PIN-related value) to the host application 302. Additionally, the host application 302 may communicate, to a suitable card expiration date application 306, a request 330 to determine an expiration date for the card to be issued. In response to the request 330, the expiration date application 306 may determine an expiration date 335 for the card to be issued, and the expiration date 335 may then be returned to the host application 302 by the card expiration date application 306. Once the host application 302 has received the key values 325 and the expiration date 335, the host application 302 may generate a message 340 including these card-specific values, and the host application 302 may communicate or direct the communication of the generated message 340 to the instant issuance application 117 to facilitate the issuance of the card. Additionally, the host application 302 may store or save information 345 associated with the instant issuance request 315 and/or the processing of the instant issuance request 315 in a suitable instant issuance database, such as a FI instant issuance database 308. The stored information 345 may be similar to the information 245 described above with reference to FIG. 2.

With continued reference to FIG. 3, once the generated message 340 is received by the instant issuance application 117, the instant issuance application 117 may utilize the card-specific values included in the message 340 to direct the printing of a card. For example, the card-specific values may be combined with a template for a card, such as a template that includes a default card image or a customer-selected card image. The resulting combination 350 may then be sent to a suitable printer device, such as the printer device 109 illustrated in FIG. 1. The printer device 109 may then print, initialize, and/or personalize a card 355. The CSR 108 may retrieve the card 355 from the printer device 109 and provide the card 355 to the customer 107. Additionally, the instant issuance application 117 may communicate a report or message associated with the final or ultimate processing of the instant issuance request 315 to the host application 302. For example, the instant issuance application 117 may periodically (e.g., once an hour, once a day, etc.) communicate, to the host application 302, a summary 360 of the instant issuance requests that have been processed by the instant issuance application 117 during the most recent reporting period. The summary 360 may include a wide variety of information associated with the processing of instant issuance requests, such as an audit trail associated with the disposition of the instant issuance requests. For example, the summary 360 may indicate, for each request, whether a card was delivered and, if a card was not delivered, a reason for the delivery failure (e.g., an indication that the process was aborted, a card production failure, etc.). The host application 302 may receive the summary 360 from the instant issuance application 117, and the host application 302 may direct the storage of at least a portion of the information included in the summary 360 in a suitable instant issuance report database 310. The stored summary information 360 may be similar to the stored information 260 described above with reference to FIG. 2.

Additionally, the host application 302 may be configured to communicate instant issuance request data 345 and/or summary information 360 or instant issuance report data to one or more external devices. For example, the host application 302 may periodically (e.g., once a day or on some other scheduled basis) communicate at least a portion of the stored instant issuance request data 345 and/or the summary information 360 to a host module or server application associated with an instant issuance service provider, such as the host module 133 associated with the II service provider 120 illustrated in FIG. 1. In certain embodiments, the host application 302 may initiate the communication of the information 345, 360. In other embodiments, the information 345, 360 may be pulled and/or requested from the host application 302 by the host module 133 of the II service provider 120. Once the information 345, 360 is received by the host module 133 of the II service provider 120, the information 345, 360 may be stored in one or more suitable databases. For example, the instant issuance request data 345 may be stored in a suitable II database, such as the II database 137 illustrated in FIG. 1. Similarly, the instant issuance summary 360 or report data may be stored in a suitable II report database, such as the II report database 138 illustrated in FIG. 1. In this regard, data repositories of instant issuance request data and/or instant issuance fulfillment data may be stored by both a FI data center 150 and an II service provider 120. The stored information may subsequently be obtained by a central issuance service provider, such as the CI service provider 135 illustrated in FIG. 1, to facilitate the suppression of central issuance orders that have previously been fulfilled by an instant issuance process.

II. Operational Overview—Central Issuance

FIG. 4 illustrates an example data flow 400 for facilitating central issuance of payment cards, according to an example embodiment of the invention. A central issuance process for issuing cards may be separate from an instant issuance process. For example, a central issuance process may be driven or triggered by a financial institution's data center. Central issuance processing within a financial institution may include the collection or assembly of various card fulfillment requests or card orders that are triggered by any number of events, including the opening of new accounts, automatic card renewals, and miscellaneous customer requests. Once card fulfillment requests have been collected, the card fulfillment requests may be communicated to a central issuance service provider, such as the service provider 135 illustrated in FIG. 1, to facilitate the provision of cards to customers. For example, a central issuance service provider 135 may direct the generation of cards and the mailing of the cards to customers. The central issuance service provider 135 may be an entity associated with a financial institution or, alternatively, a third-party service provider.

Because instant issuance processing and central issuance processing are typically not integrated within a financial institution, many central issuance orders may be duplicates of previously fulfilled instant issuance requests. According to an aspect of the invention, these duplicate orders may be identified and suppressed or removed from central issuance processing by the central issuance service provider 135 or another entity based upon an analysis of stored instant issuance data.

With reference to FIG. 4, a central issuance order generation application 405 associated with a financial institution data center (or merchant or other entity that requests central issuance of cards), such as the data center 150 illustrated in FIG. 1, may collect one or more card fulfillment requests 410 or orders from any number of data sources 415, such as branch locations, Web server applications, account management applications, bank customers, etc. These requests 410 may include orders stemming from new account openings, automatic card renewals, and/or miscellaneous customer requests. In certain embodiments, the CI order generation application 405 may generate a consolidated central issuance order file 420, and the central issuance order file 420 may be transmitted or otherwise communicated to a central issuance service provider, such as the CI service provider 135 illustrated in FIG. 1. As an alternative to transmitting a consolidated order file 420, individual orders may be transmitted to the CI service provider 135. In certain embodiments, the central issuance order file 420 may be received and processed by an II order suppression module or application associated with the CI service provider 135, such as the II order suppression application 152 illustrated in FIG. 1.

Once an order file 420 has been received by the II order suppression application 152, the II order suppression application 152 may analyze the order file 420 in order to identify orders that are duplicative of previously fulfilled instant issuance requests. In doing so, the II order suppression application 152 may access or obtain instant issuance request information 425 from a suitable II database, such as the II database 137 illustrated in FIG. 1. Additionally, the II order suppression application 152 may access or obtain instant issuance report information 430 from a suitable II report database, such as the II report database 138 illustrated in FIG. 1. In certain embodiments, one or more of the databases 137, 138 may be maintained by the CI service provider 135, and the II order suppression application 152 may directly access the databases 137, 138. For example, in embodiments in which the same service provider includes both an II service provider and a CI service provider, the II order suppression application 152 may directly access the databases 137, 138. In these embodiments, the service provider may receive and store the instant issuance information, for example, by processing instant issuance requests as described above with reference to FIG. 2. For example, a separate data record may be stored for each instant issuance request. Thus, the instant issuance data will be available to the II order suppression application 152 at a subsequent point in time. In other embodiments, the II order suppression application 152 may generate and communicate a request for instant issuance request data 425 and/or instant issuance report data 430 to one or more data sources or other service providers, such as an external II service provider.

Once instant issuance request data 425 and/or instant issuance report data 430 has been obtained by the II order suppression application 152, the II order suppression application 152 may utilize at least a portion of the obtained instant issuance data 425, 430 to identify duplicative requests included in the order file 420. For example, an account number for each central issuance request included in the order file 420 may be compared to one or more stored account numbers included in the instant issuance request data 425. As desired, an account number included in the order file 420 may be encrypted or encoded prior to the comparison(s). For example, the same one-way hash utilized to encrypt account numbers associated with instant issuance requests may be utilized to encrypt an account number included in the order file 420. In this regard, encrypted values of the account number may be compared. If it is determined that the account number of a request included in the order file 420 matches a stored account number in the instant issuance request data 425, then the II order suppression application 152 may determine that the request should be removed from the order file 420 and/or that the request should not be fulfilled via a central issuance process. Otherwise, the request may be maintained within the order file.

In a similar manner, the II order suppression application 152 may compare an account number of one or more of the central issuance requests included in the order file 420 to one or more stored account numbers included in the instant issuance report data 430. For example, if an account number match is found between a central issuance order and the II request data 425, then the account number may additionally be compared to one or more account numbers included in the II report data 430. In this regard, a determination may be made as to whether the II request was fulfilled. As another example, each of the account numbers included in the order file 420 may be compared to one or more account numbers included in the II report data 430. As desired, an account number included in the order file 420 may be encrypted or encoded prior to the comparison(s) in a similar manner as that described above with respect to the II request data comparisons. If it is determined that the account number of a request included in the order file 420 matches a stored account number in the instant issuance report data 430, then a determination may be made as to whether the matched instant issuance request included in the report data 430 has been fulfilled. If it is determined that the II request was successfully fulfilled, then the II order suppression application 152 may determine or verify that the request should be removed from the order file 420 and/or that the request should not be fulfilled via a central issuance process. If, however, it is determined that the II request was not successfully fulfilled, then the request may be maintained within the order file or a determination may be made that the request should be fulfilled.

Once the requests included in the order file 420 have been analyzed or evaluated, the II order suppression application 152 may generate a modified central issuance order file 435 that includes the central issuance requests that have not previously been fulfilled via an instant issuance process. The modified order file 435 may then be communicated to a central issuance order processing component or system 440. The CI order processing component 440 may be a component of the CI service provider 135 that facilitates the issuance of cards or a component of an external system or service provider that fulfills card requests. The CI order processing component 440 may receive the modified order file 435 and utilize the modified order file 435 to generate payment cards that can be mailed or otherwise distributed to one or more customers.

FIG. 5 is a flow diagram of an example method 500 for processing card fulfillment requests, according to an example embodiment of the invention. In certain embodiments, the operations of the method 500 may be performed by one or more CI computers associated with a CI service provider, such as the CI computers 140 associated with the CI service provider 135 of FIG. 1. Additionally, certain components of the method may be performed by one or more II computers associated with an II service provider, such as the II computers 125 associated with the II service provider 120 of FIG. 1. The method 500 may begin at block 505.

At block 505, which may be optional in certain embodiments of the invention, one or more instant issuance requests may be received and processed. For example, instant issuance requests may be received and processed in a similar manner as that described above with reference to FIGS. 2 and 3. At block 510, which may be optional in certain embodiments of the invention, information or data associated with the instant issuance requests and/or the fulfillment of the instant issuance requests (e.g., instant issuance request data, instant issuance report or summary data, etc.) may be stored in one or more suitable databases or data repositories. A data record may be generated for each instant issuance request, and a unique identifier, such as an account number or encrypted account number, may be included in the data record. In this regard, the stored information may be subsequently searched or accessed during the processing of central issuance requests.

At block 515, a central issuance order may be received. The central issuance order may include any number of central issuance requests, which may stem from such actions as new account requests, automatic card renewal requests, and/or various customer requests for new cards. Each central issuance request included in the order may be evaluated in order to determine whether the request was previously filled by an instant issuance process. At block 520, a next central issuance record or request included in the central issuance order may be selected for evaluation. At block 525, a determination may be made as to whether the end of the central issuance order file or list of requests has been reached. If it is determined at block 525 that the end of the file has been reached, then operations may end. Otherwise, operations may continue at block 530.

At block 530, which may be optional in certain embodiments of the invention, an account number associated with the selected central issuance record may be identified, and the account number may be encrypted, encoded, or otherwise processed. For example, the account number may be encrypted utilizing a one-way hash that was previously utilized during the processing of instant issuance requests. In this regard, the account number included in the central issuance record may be compared to encrypted account numbers included in stored instant issuance data. At block 535, a determination may be made as to whether stored instant issuance data is available for access. If it is determined at block 535 that stored II data is available, then operations may continue at block 540 described below. If, however, it is determined at block 535 that stored II data is not available, then operations may continue at block 545, and II data may be requested from one or more external data sources, such as a separate II service provider. The II data may then be received at block 550 in response to the request(s), and operations may continue at block 540.

At block 540, the II data may be searched utilizing the account identifier or encrypted account identifier. For example, the account identifiers associated with the selected central issuance request may be compared to one or more account identifiers associated with previous instant issuance requests. At block 555, a determination may be made as to whether the central issuance account identifier matches an instant issuance account identifier. If it is determined at block 555 that a match is not found, then operations may continue at block 560, and the selected central issuance request may be approved for fulfillment. For example, the selected CI request may be maintained in the CI order or the CI request may be written to a modified CI order. As another example, an instruction directing the CI request to be fulfilled may be generated and communicated to an order processing or fulfillment entity or component. Operations may then continue at block 520, and a next central issuance record or request may be selected.

As an alternative to obtaining II data from an external data source and examining the obtained II data in order to determine whether a CI request has previously been fulfilled via an II process, a query may be communicated to the external data source. The query may include, for example, one or more account numbers associated with instant issuance requests, which may be encrypted or unencrypted account numbers, and a request to determine whether an II process has previously been utilized to fulfill a card request for the one or more account. In response to the query, an indication of whether II requests have previously been submitted and/or fulfilled for the one or more account numbers may be returned by the external data source.

If, however, it is determined at block 555 that a match is found, then a determination may be made that an instant issuance request was previously made for the selected central issuance request. Operations may then continue at block 565. At block 565, a search may be performed for II report or summary data associated with the matched instant issuance request. In this regard, a determination may be made at block 570 as to whether the instant issuance request was fulfilled such that a card was delivered to a customer. In a similar manner as that described above for the II request data, II reports may be accessed from memory and/or obtained from one or more external data sources or service providers. If it is determined at block 570 that the card was delivered, then a determination may be made that the selected central issuance request is not to be fulfilled. Accordingly, no instruction for fulfillment will be generated and/or the central issuance request will not be written to a new or modified central issuance order. For example, if an instant issuance record indicates that the card was delivered, then the central issuance of the card will be suppressed.

If, however, it is determined at block 570 that the card was not delivered or it is determined that no II report is available for the matched instant issuance request, then operations may continue at block 560 described above, In other words, if an instant issuance request was not fulfilled, then a determination may be made that an associated central issuance request should be fulfilled. In a similar manner as that described above with respect to examining II data, any number of queries associated with the successful fulfillment of II requests may be communicated to external data sources, and indications of whether II requests were fulfilled may be returned in response to the queries. As desired, a single query may request data on whether an II request was made and whether the II request was successfully fulfilled.

The method 500 may end following block 525.

The operations described and shown in the method 500 of FIG. 5 may be carried out or performed in any suitable order as desired in various embodiments of the invention. Additionally, in certain embodiments, at least a portion of the operations may be carried out in parallel. Furthermore, in certain embodiments, less than or more than the operations described in FIG. 5 may be performed.

The invention is described above with reference to block and flow diagrams of systems, methods, apparatuses, and/or computer program products according to example embodiments of the invention. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Many modifications and other embodiments of the invention will come to mind to one skilled in the art to which this invention pertains and having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

The claimed invention is:

1. A method, comprising:
receiving a card fulfillment request associated with a financial institution and comprising information associated with an account at the financial institution;
identifying, based at least in part upon the received card fulfillment request, an account identifier associated with the account;
obtaining information associated with one or more instant issuance requests for the financial institution that have previously been approved for fulfillment, wherein the obtained information comprises a respective account identifier associated with each of the one or more instant issuance requests;
determining, based at least in part upon a comparison of the account identifier associated with the card fulfillment request to at least one of the one or more account identifiers associated with the one or more instant issuance requests, whether the account identifier associated with the card fulfillment request corresponds to one of the account identifiers associated with the one or more instant issuance requests; and
if it is determined that the account identifier associated with the card fulfillment request corresponds to one of the account numbers associated with the one or more instant issuance requests, determining that the card fulfillment request is not to be fulfilled; otherwise
if it is determined that the account identifier associated with the card fulfillment request does not correspond to any of the account numbers associated with the one or more instant issuance requests, determining that the card fulfillment request be fulfilled,
wherein the above operations are performed by one or more computers associated with a card fulfillment service provider.

2. The method of claim 1, wherein:
receiving a card fulfillment request comprises receiving the card fulfillment request as part of a set of card fulfillment requests,
determining that the card fulfillment request is not to be fulfilled comprises removing the card fulfillment request from the set of card fulfillment requests, and
determining that the card fulfillment request be fulfilled comprises directing that the card fulfillment request be maintained within the set of card fulfillment requests.

3. The method of claim 1, wherein obtaining information associated with one or more instant issuance requests comprises at least one of (i) accessing stored information associated with one or more instant issuance requests or (ii) communicating a request for instant issuance information to a remote data source and receiving, in response to the communicated request, information associated with one or more instant issuance requests.

4. The method of claim 1, further comprising:
receiving, prior to the receipt of the card fulfillment request, an instant issuance request;
generating a data record associated with the instant issuance request, wherein the data record comprises an account identifier associated with the instant issuance request; and
storing the data record in a data repository for subsequent retrieval as at least a portion of the information associated with the one or more instant issuance requests,
wherein the above operations are performed by one or more computers associated with a card fulfillment service provider.

5. The method of claim 4, wherein generating the data record comprises encrypting an account number associated with the instant issuance request to produce the account identifier associated with the instant issuance request.

6. The method of claim 1, wherein identifying an account identifier comprises encrypting an account number included in the card fulfillment request.

7. The method of claim 1, wherein receiving a card fulfillment request comprises receiving a request corresponding to one of (i) an automatic card renewal, (ii) an opening of a new account, or (iii) a customer request for a new card.

8. The method of claim 1, wherein it is determined that the account identifier associated with the card fulfillment request corresponds to one of the account numbers associated with the one or more instant issuance requests, and further comprising:
obtaining information associated with the fulfillment of the corresponding instant issuance request;
determining, based upon the fulfillment information, whether the corresponding instant issuance request has been fulfilled; and
determining that the card fulfillment request is not to be fulfilled only if it is determined that the corresponding instant issuance request has been fulfilled,
wherein the above operations are performed by one or more computers associated with a card fulfillment service provider.

9. The method of claim 1, wherein the card fulfillment request is a first request, the account is a first account, the account identifier is a first account identifier, and further comprising:
receiving a second card fulfillment request associated with the financial institution and comprising information associated with a second account at the financial institution;
identifying, based at least in part upon the received second card fulfillment request, a second account identifier associated with the second account;
determining that the second account identifier associated with the second account corresponds to another one of the account numbers associated with the one or more instant issuance requests;
obtaining fulfillment information associated with the fulfillment of the instant issuance request associated with the second account identifier;
determining, based upon the obtained fulfillment information, that the instant issuance request associated with the second account identifier has not been fulfilled; and
determining that the second card fulfillment request is to be fulfilled based at least in part on the determination that the instant issuance request associated with the second account identifier has not been fulfilled,
wherein the above operations are performed by one or more computers associated with a card fulfillment service provider.

10. The method of claim 9, wherein obtaining fulfillment information comprises one of (i) accessing stored fulfillment information or (ii) communicating a request for fulfillment information to a remote data source and receiving, in response to the communicated request, the fulfillment information.

11. A system, comprising:
at least one communications interface configured to receive a card fulfillment request associated with a financial institution and comprising information associated with an account at the financial institution; and
at least one processor configured to (i) identify, based at least in part upon the received card fulfillment request, an account identifier associated with the account, (ii) obtain information associated with one or more instant issuance requests for the financial institution that have previously been approved for fulfillment, wherein the obtained information comprises a respective account identifier associated with each of the one or more instant issuance requests, (iii) determine, based at least in part upon a comparison of the account identifier associated with the card fulfillment request to at least one of the one or more account identifiers associated with the one or more instant issuance requests, whether the account identifier associated with the card fulfillment request corresponds to one of the account identifiers associated with the one or more instant issuance requests, and (iv) if it is determined that the account identifier associated with the card fulfillment request corresponds to one of the account numbers associated with the one or more instant issuance requests, determine that the card fulfillment request is not to be fulfilled, otherwise (v) if it is determined that the account identifier associated with the card fulfillment request does not correspond to any of the account numbers associated with the one or more instant issuance requests, determine that the card fulfillment request be fulfilled.

12. The system of claim 11, wherein:
the card fulfillment request is received as part of a set of card fulfillment requests,
the at least one processor removes the card fulfillment request from the set of card fulfillment requests if it is determined that the card fulfillment request is not to be fulfilled, and
the at least one processor maintains the card fulfillment request in the set of card fulfillment requests if it is determined that the card fulfillment request is to be fulfilled.

13. The system of claim 11, wherein the at least one processor obtains information associated with one or more instant issuance requests by at least one of (i) accessing stored information associated with one or more instant issuance requests or (ii) directing the at least one communications interface to communicate a request for instant issuance information to a remote data source and receiving, in response to the communicated request, information associated with one or more instant issuance requests.

14. The system of claim 11, wherein the at least one communications interface is further configured to receive, prior to the receipt of the card fulfillment request, an instant issuance request, and
wherein the at least one processor is further configured to (i) generate a data record associated with the instant issuance request, the data record comprising an account identifier associated with the instant issuance request, and (ii) store the data record in a data repository for subsequent retrieval as at least a portion of the information associated with the one or more instant issuance requests.

15. The system of claim 14, wherein the at least one processor is further configured to encrypt an account number associated with the instant issuance request to produce the account identifier included in the generated data record.

16. The system of claim 11, wherein the at least one processor identifies the account identifier by encrypting an account number included in the card fulfillment request.

17. The system of claim 11, wherein the card fulfillment request comprises a request corresponding to one of (i) an automatic card renewal, (ii) an opening of a new account, or (iii) a customer request for a new card.

18. The system of claim 11, wherein it is determined that the account identifier associated with the card fulfillment request corresponds to one of the account numbers associated with the one or more instant issuance requests, and
wherein the at least one processor is further configured to (i) obtain information associated with the fulfillment of the corresponding instant issuance request, (ii) determine, based upon the fulfillment information, whether the corresponding instant issuance request has been fulfilled, and (iii) determine that the card fulfillment request is not to be fulfilled only if it is determined that the corresponding instant issuance request has been fulfilled.

19. The system of claim 11, wherein:
the card fulfillment request is a first request,
the account is a first account,
the account identifier is a first account identifier,
the at least one communications interface is further configured to receive a second card fulfillment request associated with the financial institution and comprising information associated with a second account at the financial institution, and
the at least one processor is further configured to (i) identify, based at least in part upon the received second card fulfillment request, a second account identifier associated with the second account, (ii) determine that the second account identifier associated with the second account corresponds to another one of the account numbers associated with the one or more instant issuance requests, (iii) obtain fulfillment information associated with the fulfillment of the instant issuance request associated with the second account identifier, (iv) determine, based upon the obtained fulfillment information, that the instant issuance request associated with the second account identifier has not been fulfilled, and (v) determine that the second card fulfillment request is to be fulfilled based at least in part on the determination that the instant issuance request associated with the second account identifier has not been fulfilled.

20. The system of claim 19, wherein the at least one processor obtains fulfillment information by one of (i) accessing stored fulfillment information or (ii) directing the at least one communications interface to communicate a request for the fulfillment information to a remote data source and receiving, in response to the communicated request, the fulfillment information.
